(19) United States
(12) Patent Application Publication
(10) Pub. No.: US 2013/0271452 A1
(43) Pub. Date: Oct. 17, 2013

(54) MECHANISM FOR FACILITATING CONTEXT-AWARE MODEL-BASED IMAGE COMPOSITION AND RENDERING AT COMPUTING DEVICES

(71) Applicants: Arvind Kumar, Beaverton, OR (US); Mark D. Yarvis, Portland, OR (US); Christopher J. Lord, Portland, OR (US)

(72) Inventors: Arvind Kumar, Beaverton, OR (US); Mark D. Yarvis, Portland, OR (US); Christopher J. Lord, Portland, OR (US)

(21) Appl. No.: 13/977,657

(22) PCT Filed: Sep. 30, 2011
(86) PCT No.: PCT/US11/54397

§ 371 Date: Jun. 28, 2013

(51) Int. Cl. G06T 17/00

(52) U.S. Cl. CPC G06T 17/00
USPC 345/419

(57) ABSTRACT

A mechanism is described for facilitating context-aware composition and rendering of virtual models and/or images of physical objects computationally composited and rendered at computing devices according to one embodiment of the invention. A method of embodiments of the invention includes performing initial calibration of a plurality of computing devices to provide point of view positions of a scene according to a location of each of the plurality of computing devices with respect to the scene, where computing devices of the plurality of computing devices are in communication with each other over a network. The method may further include generating context-aware views of the scene based on the point of view positions of the plurality of computing devices, where each context-aware view corresponds to a computing device. The method may further include generating images of the scene based on the context-aware views of the scene, where each image corresponds to a computing device, and displaying each image at its corresponding computing device.

### FIELD

The field relates generally to computing devices and, more particularly, to employing a mechanism for facilitating context-aware model-based image composition and rendering at computing devices.

### BACKGROUND

Rendering of images (e.g., three-dimensional (“3D”) images) of objects on computing devices is common. In case of 3D models being displayed, the viewed objects can be rotated and seen from different viewing angles. However, looking at multiple perspectives at the same time has challenges. For example, when looking at a single screen, a user can see one perspective of the objects at a time in a full screen view or choose to see multiple perspectives through multiple smaller windows. However, these conventional techniques are limited to a single user/device and in terms of real-time composition and renderings of multiple views.

### BRIEF DESCRIPTION OF THE DRAWINGS

Embodiments of the present invention are illustrated by way of example and not by way of limitation in the figures of the accompanying drawings, in which like references indicate similar elements and in which:

FIG. 1 illustrates a computing device employing a context-aware image composition and rendering mechanism for facilitating context-aware composition and rendering of images at computing devices according to one embodiment of the invention;

FIG. 2 illustrates a context-aware image composition and rendering mechanism employed at a computing device according to one embodiment of the invention;

FIGS. 3A illustrate various perspectives of an image according to one embodiment of the invention;

FIG. 3B-3D illustrates a scenario for context-aware composition and rendering of images using a context-aware image composition and rendering mechanism according to one embodiment of the invention;

FIG. 4 illustrates a method for facilitating context-aware composition and rendering of images using a context-aware image composition and rendering mechanism at computing devices according to one embodiment of the invention;

FIG. 5 illustrates a computing system according to one embodiment of the invention.

### DETAILED DESCRIPTION

Embodiments of the invention provide a mechanism for facilitating context-aware composition and rendering of images at computing devices according to one embodiment of the invention. A method of embodiments of the invention includes performing initial calibration of a plurality of computing devices to provide point of view positions of a scene according to a location of each of the plurality of computing devices with respect to the scene, where computing devices of the plurality of computing devices are in communication with each other over a network. The method may further include generating context-aware views of the scene based on the point of view positions of the plurality of computing devices, where each context-aware view corresponds to a computing device. The method may further include generating images of the scene based on the context-aware views of the scene, where each image corresponds to a computing device, and displaying each image at its corresponding computing device.

Furthermore, a system or apparatus of embodiments of the invention may provide the mechanism for facilitating context-aware composition and rendering of images at computing devices and perform the aforementioned processes and other methods and/or processes described throughout the document. For example, in one embodiment, an apparatus of the embodiments of the invention may include a first logic to perform the aforementioned initial calibration, a second logic to perform the aforementioned generating of context-aware views, a third logic to perform the aforementioned generating of images, a forth logic to perform the aforementioned displaying, and the like, such as other or the same set of logic to perform other processes and/or methods described in this document.

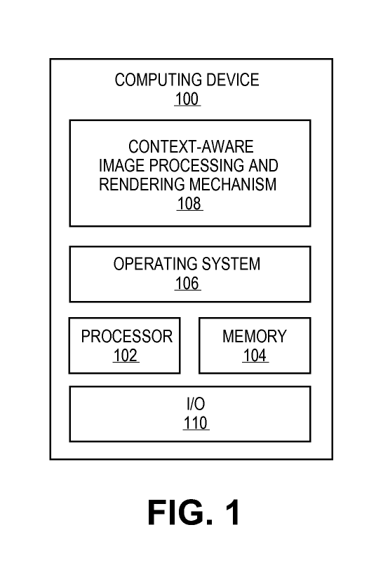

FIG. 1 illustrates a computing device employing a context-aware image composition and rendering mechanism for facilitating context-aware composition and rendering of images at computing devices according to one embodiment of the invention. In one embodiment, a computing device 100 is illustrated as having a context-aware image processing and rendering (“CIPR”) mechanism 108 to provide context-aware composition and rendering of images at computing devices. Computing device 100 may include mobile computing devices, such as cellular phones including smartphones (e.g., iPhone®, BlackBerry®, etc.), handheld computing devices, personal digital assistants (PDAs), etc., tablet computers (e.g., iPad®, Samsung® Galaxy Tab®, etc.), laptop computers (e.g., notebooks, netbooks, etc.), e-readers (e.g., Kindle®, Nook®, etc.), cable set-top boxes, etc. Computing device 100 may further include larger computing devices, such as desktop computers, server computers, etc.

In one embodiment, the CIPR mechanism 108 facilitates composition and rendering of views or images (e.g., images of objects, scene, people, etc.) in any number of directions, angles, etc., on the screen. Further, in one embodiment, if multiple computing devices are in communication with each other over a network, each user (e.g., viewer) of each of the multiple computing devices may compose and render a view or image and transmit the rendering to all other computing devices in communication over the network according to the context (e.g., placement, position, etc.) of the image as it is viewed on each particular computing device. This will be further explained with reference to the subsequent figures.

Computing device 100 further includes an operating system 106 serving as an interface between any hardware or physical resources of the computer device 100 and a user. Computing device 100 further includes one or more processors 102, memory devices 104, network devices, drivers, displays, or the like, as well as input/output sources 110, such as touchscreens, touch panels, touch pads, virtual or regular keyboards, virtual or regular mice, etc. It is to be noted that terms like “machine”, “device”, “computing device”, “computer”, “computing system”, and the like, are used interchangeably and synonymously throughout this document.

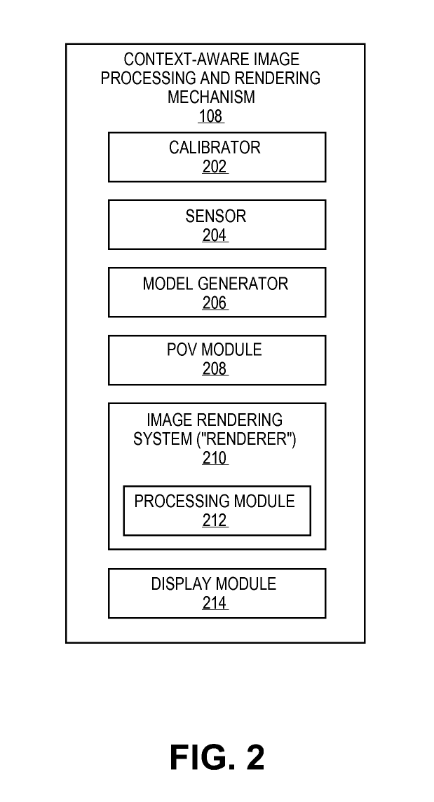

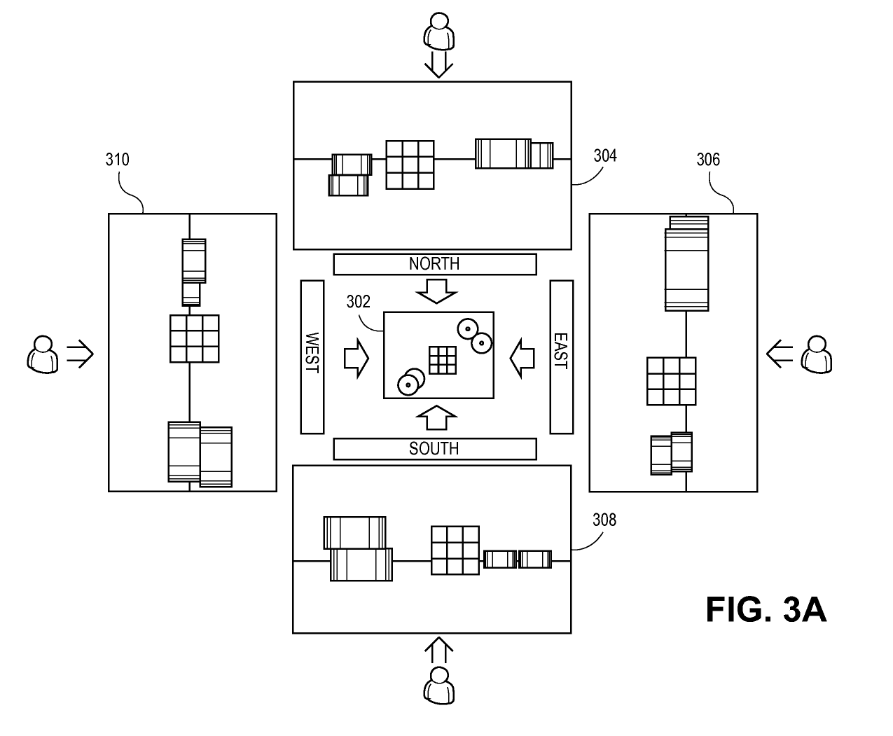

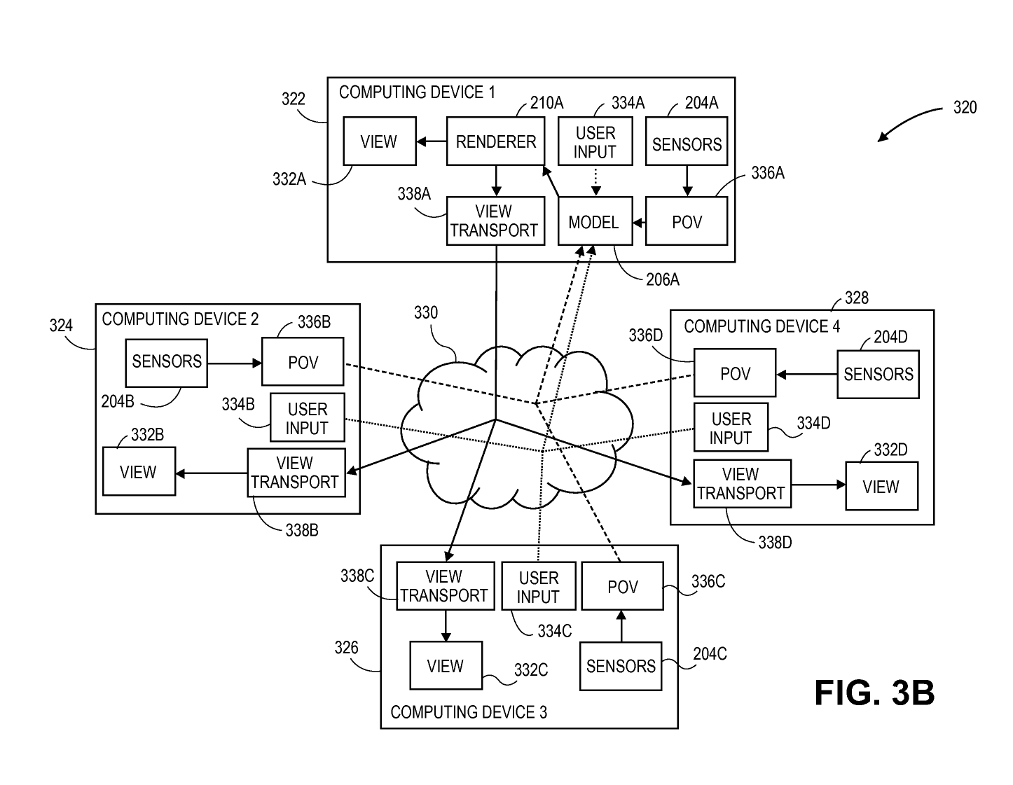

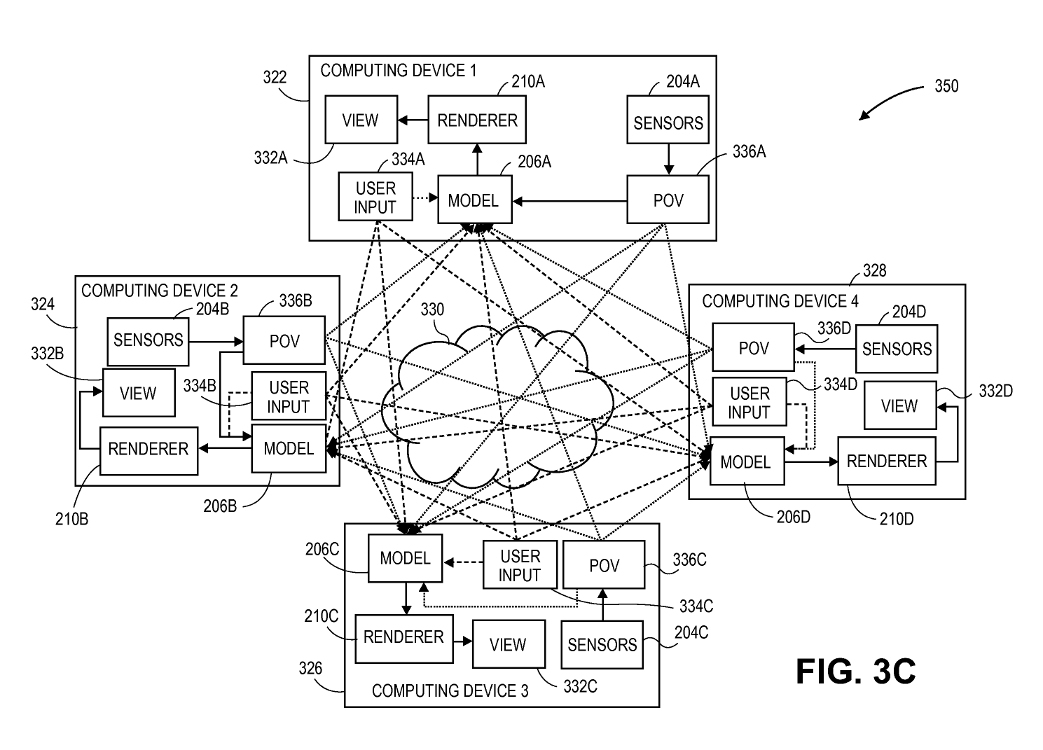

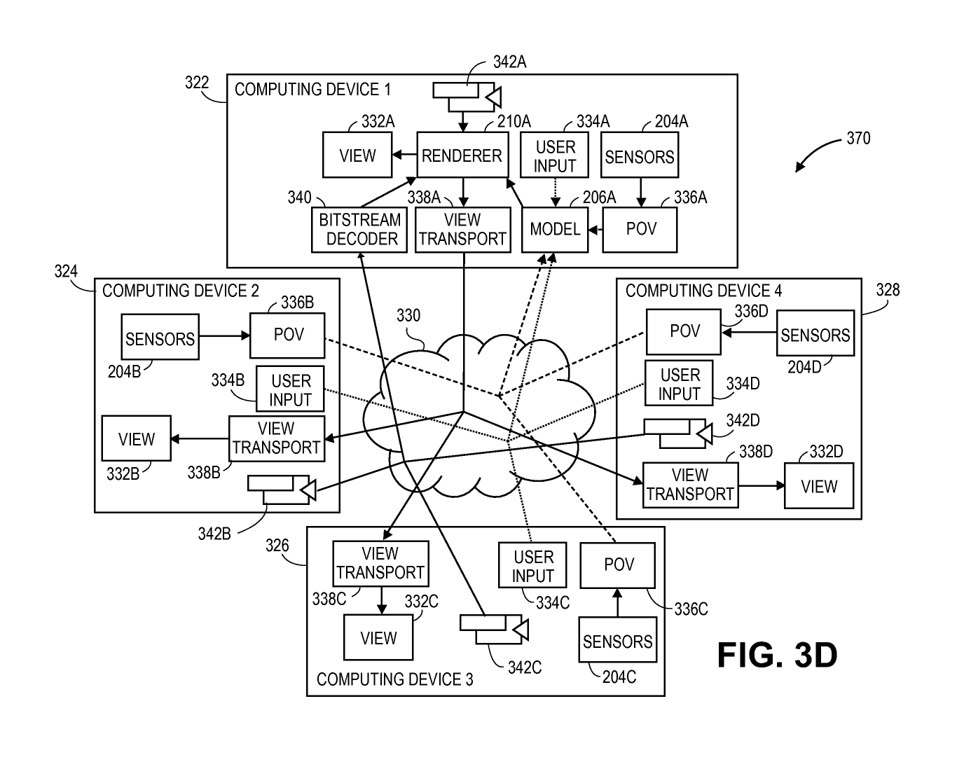

FIG. 2 illustrates a context-aware image composition and rendering mechanism employed at a computing device according to one embodiment of the invention. In one embodiment, the CIPR mechanism 108 includes a calibrator 202 to start with initial calibration of perspective point of view (“POV”) positions. The calibrator 202 can perform calibration using any number and type of methods. Calibration may be initiated with a user (e.g., viewer) inputting the current position of the computing device into the computing device using a user interface, or such position may be entered automatically, such as through a method of “bump to calibrate” which allows two or more computing devices to bump with each other and ascertain that they are at the same POV, and possibly looking into different directions, based on the values obtained by one or more sensors 204. For example, two notebook computers may be placed back-to-back looking at virtual objects from two opposite sides. Once the initial calibration is performed, any movement is detected by the sensors 204 and then relayed to an image rendering system (“renderer”) 210 for processing through its processing module 212. This image rendering may be performed on a single computing device or on each individual computing device. Once the image is rendered, it is then displayed, via a display module 214, on each of the computing devices connected via a network (e.g., Internet, intranet, etc.). To further explain, three different relevant scenarios will be described with reference to FIGS. 3B-3D.

In one embodiment, the CIPR mechanism 108 further includes a model generator 206 to generate a model (e.g., 3D computer model) of an object, a scene, etc., using one or more cameras covering all sides of a real life image and then, for example, using one or more programming techniques or algorithms. The computing device hosting the CIPR mechanism 108 may further employ or be in communication with one or more cameras (not shown). Further, the model generator 206 may generate these model images using, for example, computer graphics and/or based on, for example, mathematical models of geometry, texture, coloring, lighting of the scene, etc. A model generator may also generate model images based on physics that describe how the image's objects (or scenes, people, etc.) act over time, interact with each other, and react to external stimulus (e.g., a virtual touch by one of the user, etc.). Further, it is to be noted that these model images could be still images or a time-based sequence of multiple images as in a video steam.

The CIPR mechanism 108 further includes a POV module 208 to provide a perspective POV that fixes the position of the user/viewer who needs to see a 3D image from a specific orientation and position in space, relative to the original positioning of the model. Here, in one embodiment, the perspective POV may refer to the position of the computing device that needs to render the model from where the computing device is located. A perspective view window (“view”) shows the model as seen from the POV. The view may be obtained by applying one or more image transformation methods on the model, which is referred to as perspective rendering.

One or more sensors 204 (e.g., motion sensors, location sensors, etc.) facilitate a computing device to determine its POV. For example, computing devices can enumerate themselves, choose a leader computing device from multiple computing devices, compute equidistant points around, for example, a circle (e.g., 90-degrees of separation of four computing devices, etc.), select fixed POVs around the model, etc. Further, using a compass, the degree of rotation of the POV in a circle around the model may be automatically determined. Sensors 204 could be special hardware sensors like accelerometers, gyrometers, compass, inclinometer, global positioning system (GPS) etc., which can be used to detect the motion, relative movement, orientation and location. Sensors 204 may include software sensors that use mechanisms, such as detecting signal strength of various wireless transmitters, or the proximity of WiFi access points around computing devices to determine the location. Such fine-grained sensor data may be used to determine each user's position in space and orientation, relative to the model. Regardless of the method used, it is sensor data that is calculated or obtained that is of relevance here.

It is contemplated that any number and type of components may be added to and removed from the CIPR mechanism 108 to facilitate the workings and operability of the CIPR mechanism 108 for providing context-aware composition and rendering of images at computing devices between computing devices. For brevity, clarity, ease of understanding and to focus on the CIPR mechanism 108, many of the default or known components of various devices, such as computing devices, cameras, etc., are not shown or discussed here.

FIG. 3A illustrates various perspectives of an image according to one embodiment of the invention. As illustrated, various objects 302 are placed on a table. Now let us suppose, four users with their computing devices (e.g., tablet computer, notebook, smartphone, desktop, etc.) are sitting around the table (or remotely watching a virtual image of the objects 302 on their computing devices. As illustrated, these images 304, 306, 308, and 310 are seen different from four different locations north, east, south, and west, respectively, and these images changes as the users or their computing devices or the objects 302 on the table move around. For example, of one of the objects 302 is moved on or removed from the table, each of the four images 302-310 changes in accordance with the change in the current placement of the objects 302 on the table.

For example, as illustrated, if the images 302-310 are views of a 3D model of the objects 302 on the table, each image provides a different 3D view of the virtual objects 302. Now, in one embodiment, if a virtual object being shown in an image, such as image 310, is moved by the user in a virtual space on his computing device (e.g., using a mouse, keyboard, touch panel, touchpad, or the like), all images 304-310 being rendered on their respective computing devices change according to their own POV as if one of the real objects 302 (as opposed to a virtual object) was moved. Similarly, in one embodiment, a computing device, such as the one rendering image 310, is moved for any reason, such as by the user or accident or some other reason, the rendering of the image 310 on that computing device also changes. For example, if the computing device is brought closer to the center, the image 310 provide a zoom-in or bigger view of the virtual images representing the real images 302 and in contrast, if the computing device is moved away, the image 310 show a distant, zoom-out, view of the virtual objects. In other words, it seems or represents as if a real person is looking at real objects 302.

It is contemplated that the objects 302 illustrated here are merely used as examples and for brevity, clarity and ease of understanding and that embodiments of the invention are compatible to and work with all sorts of objects, things, persons, scenes, etc. For example, instead of the objects 302, a building may be viewed in the images 302-310. Similarly, for example, a soccer game's various real-time high-definition 3D views from various sides or ends, such as north, east, south and west, may be rendered by the corresponding images 304, 306, 308 and 310, respectively. It is further contemplated that the images are not limited to four sides as illustrated here and that any number of sides may be captured, such as north-east, south-west, above, below, circular, etc. Further, for example, in case of an interactive game, in one embodiment, multiple players may sit around a table (or in their respective homes or elsewhere) playing a game, such as a board game, like scrabble, with each computing device sees the game board from its own directional perspective.

For example, a game of tennis with two screens of two computing device being used by two players may allow a first user/player at his home to virtually hit and send the tennis ball to the other side of the virtual court to a second user/player at her office. The second player receives the virtual ball and hits it back to the first player or misses it or hits is virtually out-of-bounds, etc. Similarly, four users/players can play a doubles game and other additional user can serve as audiences watching the virtual game from their own individual perspective based on their own physical location/position and context to, for example, the virtual tennis court. These users may be in the same room or spread around the world in their homes, offices, parks, beaches, streets, busses, trains, etc.

FIG. 3B illustrates a scenario for context-aware composition and rendering of model using a context-aware image composition and rendering mechanism according to one embodiment of the invention. In scenario 320, in one embodiment, a set of multiple computing devices 322-328 is communicating over a network 330 (e.g., Local Area Network (LAN), Wireless LAN (WLAN), Wide Area Network (WAN), Metropolitan Area Network (MAN), Personal Area Network (PAN), Bluetooth, Internet, intranet, etc.), a single computing device 322 includes a model 206A and assumes the responsibility of generating views for multiple POVs 336A, 336B, 336C, 336D for multiple computing devices 322-328 based on the location data received from the computing devices 322-328. Each computing device 322-328 may have its own POV module (as shown POV module 208 in FIG. 2), so the POV 336A-336D may be determined by each computing device 322-328 and transmitted to computing device 322. Each PV 336A-336D is added to the model 206A so that the renderer 210A may generate all the views 332A-332D. In the illustrated embodiment, each computing device 322, 324, 326, 328 has a POV 336A-D of itself, while in another embodiment, the computing device 322 may generate POVs 336B-336D for other participating computing devices 334-328 based on data from their individual sensors 204A-D. Computing devices 322-328 may include smartphones, tablet computers, notebooks, netbooks, e-readers, desktops, or the like, or any combination thereof, etc.

In one embodiment, the CIPR mechanism at computing device 322 generates multiple views 332A-332D, each of which is then sent to a corresponding computing device 322-328 using a transfer process known as display redirection that is performed by the display module in combination with the processing module of the renderer 210 of the CIPR mechanism as referenced with respect to FIG. 2. The process of display redirection may involve a forward process of encoding of the graphical contents of the view window, compressing the contents for efficient transmission, and sending each view 332B-332D to its corresponding target computing device 324-328, where through the processing module a reverse process of uncompressing, decoding, and rendering the image based on the view 332B-332D on the display screen of each of the computing device 324-328. Regarding the main computing device 322, the processes may be performed internally, such that the view 332A is generated, processed for display redirection (forward and reverse processing), and displayed on the screen at the computing device 322. Further, as illustrated, sensors 204A-D are provided to sense the context-aware location, position, etc. of each of the computing device 322-328 with respect to the object or scene, etc., that is being viewed so that proper POVs 336A-336D and views 332A-332D may be appropriately generated.

User inputs 334A-334D refer to inputs provided by the users of any of the computing devices 322-328 via a user interface and input devices (e.g., keyboard, touch panel, mouse, etc.) at each of the computing devices 322-328. These user inputs 334A-334D may involve a user, such as at computing device 326, requesting a change or movement of any of the objects or scenes being viewed on the display screen of computing device 326. For example, a user may choose to drag and move a virtual object being viewed from one portion of the screen to another, which can then change the view of the virtual object for each of the other users and accordingly, new views 332A-332D are generated by the CIPR mechanism at computing device 322 and rendered for viewing at itself and other computing devices 324-328. Or a user may add or remove a virtual object from the display screen of computing device 326, resulting in addition or removal of a view of a virtual object from views 332A-332D, depending on whether that object was visible from the POV of each device 322-328.

Now referring to FIG. 3C, it illustrates a scenario for context-aware composition and rendering of images using a context-aware image composition and rendering mechanism according to one embodiment of the invention. For brevity, some of the components discussed with reference to FIG. 3B and other preceding figures will not be discussed here. In this scenario 350, each computing device 322-328 includes a model 206A-206B (e.g., the same model). This model 206A-206D may be downloaded or streamed from a central server, such as from the Internet, or served from one or more of the participating computing devices 322-328 in communication over a network 330. Based on its own location data, each of the computing devices 322-328 performs and processes its own POV 336A-336D and generates the corresponding views 332A-332D and performs relevant transformations, including the process of display redirection and its forward and reverse processes, and renders the resulting image on its own display screen. This scenario 350 may use additional data transfer and time synchronization of display of the content independently of each participating computing device 322-328. Further, with user interaction through a user interface, each computing device 322-328 may be allowed to update its own model 206A-206D.

FIG. 3D illustrates a scenario for context-aware composition and rendering of images using a context-aware image composition and rendering mechanism according to one embodiment of the invention. For brevity, various components discussed with reference to FIGS. 3B-3C and other preceding figures will not be discussed here. In this scenario 370, each computing device 322-328 employs its own camera 342A-342D (e.g., any type or form of video capture device) pointing towards the objects or scene being observed. As an example, to calibrate the computing devices 322-328, a physical object (e.g., a cube with specific markings) may be placed somewhere where a computing device 322-328 can face the object and be adjusted until its proper calibration is achieved. Further, metadata, including 3D camera location, may be annotated into a compressed video bitstream. In one embodiment, POVs 336A-336D may be used to transmit compressed video of a physical scene or objects and its 3D coordinates to the renderer(s) 210A.

Once the calibration is accomplished, an original view 332A-332D can be annotated in the compressed bitstream. Further, as any of the computing devices 322-328 is moved (e.g., moved slightly or greatly, removed entirely from participating, or if a computing device is added to participate, etc.), its 3D location is recalculated or determined and a physical video (or a still image) is compressed and transmitted, as in FIG. 3B, to a centralized renderer at a single/chosen computing device 322 or, as in FIG. 3C, to multiple renderers at multiple computing devices 322-328. At each computing device 322-328, the received video (or the still image) goes through the reverse process of decompressing, decoding by a bitstream decoder 340, etc., and the 3D metadata is used to composite the physical and virtual models into a video buffer.

In one embodiment, each computing device 322-328 is calibrated once and then may continuously capture videos or still images using the cameras 342A-342D followed compression, annotation, transmission and reception of the bitstream (and/or the sill image), etc. The receiving (compositing) computing device 322-328 may use the bitstream (and/or still image) and the virtual model 206A to build multiple views 332A-332B that are then compressed and transmitted and then received and decompressed and then displayed on display screens of the computing devices 322-328. While a model 206A may be rendered for each view 332A-332D, it may also be changing. For example, a given model 206A may include a physical engine, which describes how various components of the model 206A are moved over time and interact with each other. Further, the user may also be able to interact with the model 206A by clicking or touching the objects or scenes in the model 206A or by using any other interface mechanism (e.g., keyboard, mouse, etc.). In such a case, the model 206A may be updated, which is likely to affect or alter each individual view 332A-332D. Additionally, if the model 206A is being rendered by each individual computing device 322-328, a relevant update of the model 206A may be transmitted or delivered by the renderer 210A to the main computing device 322 and other computing devices 324-328 so that the views 332A-332D may be updated. Transformed images of the updated views 332A-332D may then be displayed on display screens of the computing devices 322-328.

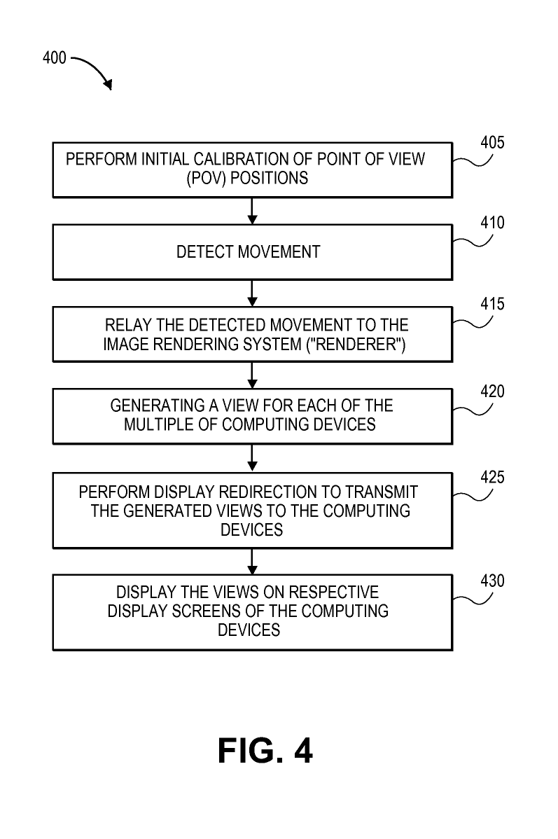

FIG. 4 illustrates a method for facilitating context-aware composition and rendering of images using a context-aware image composition and rendering mechanism at computing devices according to one embodiment of the invention. Method 400 may be performed by processing logic that may comprise hardware (e.g., circuitry, dedicated logic, programmable logic, etc.), software (such as instructions run on a processing device), or a combination thereof. In one embodiment, method 400 may be performed by the CIPR mechanism of FIG. 1 on a plurality of computing devices

Method 400 begins with block 405 with calibration of multiple participating computing devices in communication over a network to achieve proper calibration and POV positions in reference to an object or a scene, etc., that is being viewed. At block 410, any movement of the computing devices and/or of the object or something in the scene is detected or sense by one or sensors. At block 415, the detected movement is related to a renderer at a computing device that is chosen as the main computing device hosting the CIPR mechanism according to one embodiment. In another embodiment, multiple devices may employ the CIPR mechanism. At block 420, views are generated for each of the multiple computing devices. At block 425, display redirection (e.g., forward processing, reverse processing, etc.) is performed for each of the views so that corresponding images of the views can be generated. At block 430, these images are then displayed on display screens of the participating computing devices.

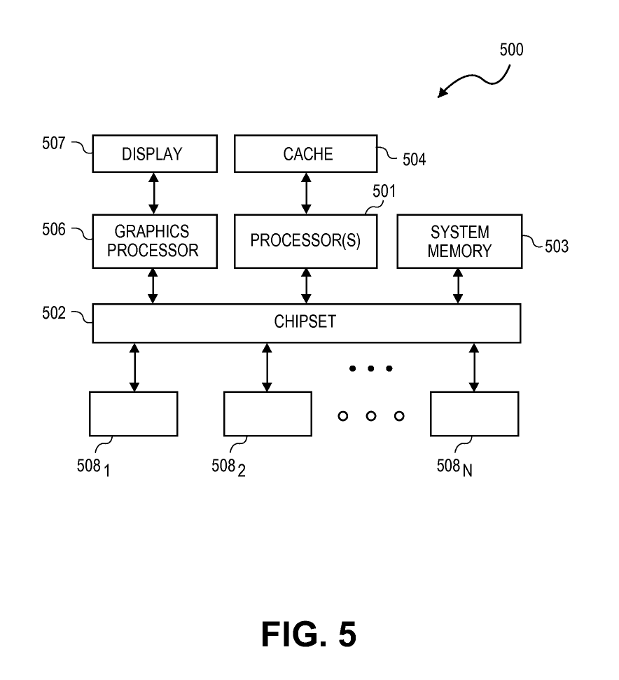

FIG. 5 illustrates a computing system employing a context-aware image mechanism to facilitating context-aware composition and rendering of images according to one embodiment of the invention. The exemplary computing system 500 may be the same as or similar to the computing devices 100, 322-328 of FIGS. 1 and 3B-3D and include: 1) one or more processors 501 at least one of which may include features described above; 2) a chipset 502 (including, e.g., memory control hub (MCH), I/O control hub (ICH), platform controller hub (PCH), System-on-a-Chip (SoC), etc.); 3) a system memory 503 (of which different types exist such as double data rate RAM (DDR RAM), extended data output RAM (EDO RAM) etc.); 4) a cache 504; 5) a graphics processor 506; 6) a display/screen 507 (of which different types exist such as Cathode Ray Tube (CRT), Thin Film Transistor (TFT), Light Emitting Diode (LED), Molecular Organic LED (MOLED), Liquid Crystal Display (LCD), Digital Light Projector (DLP), etc.; and 8) one or more I/o devices 508.

The one or more processors 501 execute instructions in order to perform whatever software routines the computing system implements. The instructions frequently involve some sort of operation performed upon data. Both data and instructions are stored in system memory 503 and cache 504. Cache 504 is typically designed to have shorter latency times than system memory 503. For example, cache 504 might be integrated onto the same silicon chip(s) as the processor(s) and/or constructed with faster static RAM (SRAM) cells whilst system memory 503 might be constructed with slower dynamic RAM (DRAM) cells. By tending to store more frequently used instructions and data in the cache 504 as opposed to the system memory 503, the overall performance efficiency of the computing system improves.

System memory 503 is deliberately made available to other components within the computing system. For example, the data received from various interfaces to the computing system (e.g., keyboard and mouse, printer port, LAN, port, modem port, etc.) or retrieved from an internal storage element of the computer system (e.g., hard disk drive) are often temporarily queued into system memory 503 prior to their being operated upon by the one or more processor(s) 501 in the implementation of a software program. Similarly, data that a software program determines should be sent from the computing system to an outside entity through one of the computing system interfaces, or stored into an internal storage element, is often temporarily queued in system memory 503 prior to its being transmitted or stored.

The chipset 502 (e.g., ICH) may be responsible for ensuring that such data is properly passed between the system memory 503 and its appropriate corresponding computing system interface (and internal storage device if the computing system is so designed). The chipset 502 (e.g., MCH) may be responsible for managing the various contending requests for system memory 503 accesses amongst the processor(s) 501, interfaces and internal storage elements that may proximately arise in time with respect to one another.

One or more I/O devices 508 are also implemented in a typical computing system. I/O devices generally are responsible for transferring data to and/or from the computing system (e.g., a networking adapter); or, for large scale non-volatile storage within the computing system (e.g., hard disk drive). The ICH of the chipset 502 may provide bi-directional point-to-point links between itself and the observed I/O devices 508.

Portions of various embodiments of the present invention may be provided as a computer program product, which may include a computer-readable medium having stored thereon computer program instructions, which may be used to program a computer (or other electronic devices) to perform a process according to the embodiments of the present invention. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

In the foregoing specification, the invention has been described with reference to specific exemplary embodiments thereof. It will, however, be evident that various modifications and changes may be made thereto without departing from the broader spirit and scope of the invention as set forth in the appended claims. The Specification and drawings are, accordingly, to be regarded in an illustrative rather than a restrictive sense.

1. A computer-implemented method comprising:
performing initial calibration of a plurality of computing devices to provide point of view positions of a scene according to a location of each of the plurality of computing devices with respect to the scene, wherein the plurality of computing devices are in communication with each other over a network;
generating context-aware views of the scene based on the point of view positions of the plurality of computing devices, wherein each context-aware view corresponds to a computing device;
generating images of the scene based on the context-aware views of the scene, wherein each image corresponds to a computing device; and
displaying each image at its corresponding computing device.

2. The computer-implemented method of claim 1, further comprising:
detecting manipulation of one or more objects of the scene; and
performing recalibration of the plurality of computing devices to provide new point of view positions based on the manipulation.

3. The computer-implemented method of claim 2, further comprising:
generating new context-aware views of the scene based on the new point of view positions;
generating new images of the scene based on the new context-aware views of the scene; and
displaying each new image at its corresponding computing device.

4. The computer-implemented method of claim 1, further comprising:
detecting a movement of one or more computing devices of the plurality of computing devices; and
performing recalibration of the plurality of computing devices to provide new point of view positions based on the movement.

5. The computer-implemented method of claim 4, further comprising:
generating new context-aware views of the scene based on the new point of view positions;
generating new images of the scene based on the new context-aware views of the scene; and
displaying each new image at its corresponding computing device.

6. The computer-implemented method of claim 1, wherein generating images of the scene comprises performing one or more virtual display redirections to transmit the images to their corresponding computing devices, wherein the display redirection comprises a forward process including compression, coding, transmitting of the images, and a reverse process including decompression, decoding, and receiving of the images.

7. The computer-implemented method of claim 1, wherein the plurality of computing devices comprise one or more of smartphones, personal digital assistants (PDAs), handheld computers, e-readers, tablet computers, notebooks, netbooks, and desktop computers.

8. A system comprising:
a computing device having a memory to store instructions, and a processing device to execute the instructions, wherein the instructions cause the processing device to:
perform initial calibration of the computing device to provide point of view position of a scene according to a location of the computing device with respect to the scene, and communicate information relating to the initial calibration to one or more computing devices to perform respective one or more initial calibration to provide point of view positions of the scene according to a location of each of the one or more computing devices with respect to the scene;
generate a context-aware view of the scene based on the point of view position of the computing device;
generate an image of the scene based on the context-aware view of the scene, wherein the image corresponds to the computing device; and
display the image at the computing device.

9. The system of claim 8, wherein the processing device is further to:
detect manipulation of one or more objects of the scene; and
perform recalibration of the computing device to provide a new point of view position based on the manipulation.

10. The system of claim 9, wherein the processing device is further to:
generate a new context-aware view of the scene based on the new point of view position;
generate a new image of the scene based on the new context-aware view of the scene; and
display a new image at the computing device.

11. The system of claim 8, wherein the processing device is further to:
detect a movement of the computing device; and
perform recalibration of the computing device to provide a new point of view position based on the movement.

12. The system of claim 11, wherein the processing device is further to:
generate a new context-aware view of the scene based on the new point of view position;
generate a new image of the scene based on the new context-aware view of the scene; and
display a new image at the computing device.

13. The system of claim 8, wherein generating the image of the scene comprises performing one or more virtual display redirections to transmit the image to the computing device, wherein the display redirection comprises a forward process including compression, coding, transmitting of the image, and a reverse process including decompression, decoding, and receiving of the image.

14. The system of claim 8, wherein the computing device comprises a smartphone, a personal digital assistant (PDA), a handheld computer, an e-reader, a tablet computer, a notebook, a netbook, and a desktop computer.

15. A machine-readable medium including instructions that, when executed by a computing device, cause the computing device to:
perform initial calibration of the computing device to provide point of view position of a scene according to a location of the computing device with respect to the scene, and communicate information relating to the initial calibration to one or more computing devices to perform respective one or more initial calibration to provide point of view positions of the scene according to a location of each of the one or more computing devices with respect to the scene;
generate a context-aware view of the scene based on the point of view position of the computing device;
generate an image of the scene based on the context-aware view of the scene, wherein the image corresponds to the computing device; and
display the image at the computing device.

16. The machine-readable medium of claim 13, further comprises one or more instructions that, when executed by the computing device, further cause the computing device to:
detect manipulation of one or more objects of the scene; and
perform recalibration of the computing device to provide a new point of view position based on the manipulation.

17. The machine-readable medium of claim 14, further comprises one or more instructions that, when executed by the computing device, further cause the computing device to:
generate a new context-aware view of the scene based on the new point of view position;
generate a new image of the scene based on the new context-aware view of the scene; and
display a new image at the computing device.

18. The machine-readable medium of claim 13, further comprises one or more instructions that, when executed by the computing device, further cause the computing device to:
detect a movement of the computing device; and
perform recalibration of the computing device to provide a new point of view position based on the movement.

19. The machine-readable medium of claim 14, further comprises one or more instructions that, when executed by the computing device, further cause the computing device to:
generate a new context-aware view of the scene based on the new point of view position;
generate a new image of the scene based on the new context-aware view of the scene; and
display a new image at the computing device.

20. The machine-readable medium of claim 13, wherein generating the image of the scene comprises performing one or more virtual display redirections to transmit the image to the computing device, wherein the display redirection comprises a forward process including compression, coding, transmitting of the image, and a reverse process including decompression, decoding, and receiving of the image.

21. (canceled)
